(19) United States
(12) Patent Application Publication
(10) Pub. No.: US 2011/0310306 A1
(43) Pub. Date: Dec. 22, 2011

(54) DISPLAY APPARATUS AND DISPLAY SYSTEM USING THE SAME

(75) Inventor: Jung-kyun SHIN, Suwon-si (KR)

(73) Assignee: SAMSUNG ELECTRONICS CO., LTD., Suwon-si (KR)

(21) Appl. No.: 13/220,233

(22) Filed: Aug. 29, 2011

Related U.S. Application Data
(63) Continuation of application No. 11/138,303, filed on May 27, 2005.

(30) Foreign Application Priority Data
May 28, 2004 (KR) 10-2004-0038452

(51) Int. Cl. H04N 5/44

(52) U.S. Cl. 348/725; 348/E05.096; 348/E05.133

(57) ABSTRACT

A display apparatus includes a display part displaying a picture thereon, and a video signal processor formatting an input video signal to be displayed by the display part. The display apparatus also includes a video reproducer reproducing video data into a video signal to be processed by the video signal processor, a network module connected to a network and transmitting/receiving data through a predetermined protocol, and a controller abstracting the video data from the data received through the network module, controlling the video reproducer to reproduce the video data as a video signal to be processed by the video signal processor, and transmitting the video signal to the video signal processor. With this configuration, a display apparatus and display system is provided in which a plurality of display apparatuses is connected to a computer through a network and displays a picture based on data received from the computer through the network.

### CROSS-REFERENCE TO RELATED APPLICATIONS

This is a continuation of U.S. application Ser. No. 11/138,303, filed May 27, 2005, which claims priority from Korean Patent Application No. 2004-38452, filed May 28, 2004, in the Korean Intellectual Property Office, the disclosures of which are incorporated herein in their entireties by reference.

### BACKGROUND OF THE INVENTION

1. Field of the Invention

The present invention relates to a display apparatus and a display system, and more particularly, to a display apparatus and a display system, in which a plurality of display apparatuses is connectable to a computer through a network.

2. Description of the Related Art

Generally, a display apparatus such as a liquid crystal display (LCD), a plasma display panel (PDP), or the like is employed in various fields including televisions, computer monitors, etc., for displaying a picture.

In the case where the display apparatus is employed for the monitor of the computer, the display apparatus has multiple functions that include displaying a picture based on a television-broadcasting signal received through a built-in television tuner, converting a sound signal received from the computer into an audible signal through a built-in speaker, etc., as well as displaying a picture based on a video signal received from the computer. Such a display apparatus having multiple functions is called a multi-function monitor.

Meanwhile, there has recently been used a D-SUB connector or a digital video interface (DVI) connector to connect the monitor with the computer, through which the video signal is transmitted from the computer to the monitor. Further, in the case of the multi-function monitor, there is provided an S-video connector, a component connector, or a composite connector in addition to the D-SUB connector or the DVI connector, thereby allowing the multi-function monitor to receive the video signal from an external device such as a digital versatile disk (DVD) player, a video cassette recorder (VCR), or the like.

Accordingly, the computer also tends not to support only one output connector such as the D-SUB connector or the like, but to support two or more output connectors including the D-SUB connector, the DVI connector, the S-video connector, etc. Thus, it is possible to connect to two or more monitors with the computer.

However, in the conventional computer, the number of output connectors is limited due to the limited connector installation space of the computer, so that the number of monitors to be connected to one computer is limited.

Therefore, when a plurality of monitors is connected to one computer, for example, when connected to one server computer, or when employed for displaying the same picture in an exhibition or the like, there is separately needed a multi-connector that extends a cable between the connectors.

However, in the case where the multi-connector is used for connecting the plurality of monitors to one computer, the extended cable brings problems with treatment of the cable, picture quality of the monitor due to loss or noise in the video signal, and so on.

### SUMMARY OF THE INVENTION

Accordingly, it is an exemplary aspect of the present invention to provide a display apparatus and a display system, in which a plurality of display apparatuses is connected to a computer through a network and displays pictures based on data received from the computer through the network.

Another exemplary aspect of the present invention is to provide a display system in which a display apparatus is connected to an external device and displays a picture based on data received from the external device.

The foregoing and/or other exemplary aspects of the present invention are also achieved by providing a display apparatus comprising a display part displaying a picture thereon, and a video signal processor formatting an input video signal to be displayed by the display part, the display apparatus comprising a video reproducer reproducing video data into a video signal to be processed by the video signal processor; a network module connected to a network and transmitting/receiving data through a predetermined protocol; and a controller abstracting the video data from the data received through the network module and controlling the video reproducer to reproduce the video data as a video signal to be processed by the video signal processor and to transmit the video signal to the video signal processor.

According to an exemplary aspect of the present invention, the display apparatus further comprises an audio reproducer reproducing audio data, the controller abstracting the audio data from the data received through the network module, and controlling the audio reproducer to reproduce and output the audio data.

According to another exemplary aspect of the present invention, the display apparatus further comprises a data interface connected to an external device and transmitting/receiving data to/from the external device, the controller abstracting the video data and the audio data from the data received through the data interface, and controlling the video reproducer and the audio reproducer to reproduce and output the video data and the audio data, respectively.

According to yet another exemplary aspect of the present invention, the data interface is connected to the external device through a USB.

According to still yet another exemplary aspect of the present invention, the controller comprises a control routine to control the video reproducer, the network module, the audio reproducer and the data interface; a memory loading the control routine therein; and a CPU executing the control routine in the memory.

According to still yet another exemplary aspect of the present invention, the video reproducer comprises a codec program operating on the basis of the control routine to reproduce the video data received through the network module.

According to still yet another exemplary aspect of the present invention, the display apparatus further comprises a viewer program operating on the basis of the control routine, the control routine abstracting viewer data to be reproduced by the viewer program from the data received through the network module, and controlling the viewer program to convert the abstracted viewer data to be reproduced by the video reproducer.

According to still yet another exemplary aspect of the present invention, the display apparatus further comprises a data storage storing the control routine, and a control signal output part outputting a first control signal and a second control signal to the CPU according to a user's handling, the control routine controlling the data received through at least one of the network module and the data interface to be stored in the data storage when the CPU receives the first control signal, and controlling the control routine to read out the data stored in the data storage, and at least one of the video reproducer and the audio reproducer to reproduce the read data when the CPU receives the second control signal.

The foregoing and/or other aspects of the present invention are also achieved by providing a display system comprising at least one display apparatus; and a computer connected to the display apparatus through the network and communicating data with the network module of the display apparatus through the protocol.

According to an exemplary aspect of the present invention, the display apparatus further comprises an audio reproducer reproducing audio data, the controller abstracting the audio data from the data received through the network module, and controlling the audio reproducer to reproduce and output the audio data.

According to another exemplary aspect of the present invention, the display system further comprises at least one external device connected to the display apparatus and communicating data with the display apparatus; and a data interface connected to the external device and transmitting/receiving data to/from the external device, wherein the display apparatus further comprises a data interface connected to the external device through a USB, and the controller abstracts the video data and the audio data from the data received through the data interface, and controls the video reproducer and the audio reproducer to reproduce and output the video data and the audio data, respectively.

### BRIEF DESCRIPTION OF THE DRAWINGS

The above and/or other aspects and advantages of the present invention will become apparent and more readily appreciated from the following description of the embodiments, taken in conjunction with the accompany drawings of which:

FIG. 1 is a control block diagram of a display apparatus according to an exemplary embodiment of the present invention;

FIG. 2 is a control block diagram of a display apparatus according to another exemplary embodiment of the present invention;

FIG. 3 is a more detailed control block diagram of the display apparatus of FIG. 2;

FIG. 4 is a view illustrating configurations of a display system according to an exemplary embodiment of the present invention; and

FIG. 5 is a view illustrating configurations of a display system according to another exemplary embodiment of the present invention.

### DETAILED DESCRIPTION OF THE PREFERRED EMBODIMENT

Reference will now be made in detail to the exemplary embodiments of the present invention, examples of which are illustrated in the accompanying drawings, wherein like reference numerals refer to like elements throughout. The exemplary embodiments are described below in order to explain the present invention by referring to the figures.

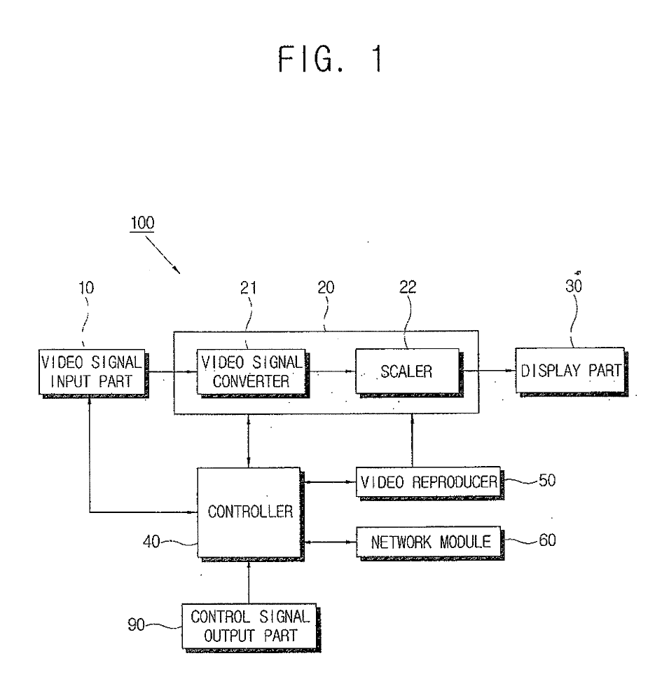

As shown in FIG. 1, a display apparatus 100 according to an exemplary embodiment of the present invention comprises a video signal input part 10, a video signal processor 20, a display part 30, and a controller 40 controlling the video signal input part 10, the video signal processor 20 and the display part 30. Further, the display apparatus 100 according to an embodiment of the present invention comprises a network module 60, and a video reproducer 50.

The display part 30 converts a video signal transmitted from the video signal processor 20 into a visible signal. The display part 30 comprises a display module (not shown) on which a picture is displayed, and a display module driver (not shown) driving the display module to display a picture based on an input video signal.

The display module according to an exemplary embodiment of the present invention includes various display modules such as digital light processing (DLP), an LCD, a PDP, etc. In the case where the DLP is used as the display module, the display module driver comprises an optical engine. In the case where the LCD is used as the display module, the display module driver comprises a printed circuit board (PCB) converting the video signal into a data signal and a gate signal.

The video signal processor 20 formats the video signal input from the video signal input part 10 or the video signal reproducer 50 to be displayed by the display part 30. As shown in FIG. 1, the video signal processor 20 according to an exemplary embodiment of the present invention comprises a scaler 22 and a video signal converter 21 digitalizing the video signal input from the video signal input part 10 to be processed by the scaler 22.

Here, the video signal converter 21 comprises at least one of a transition minimized differential signaling (TMDS) receiver (not shown), an analog/digital (A/D) converter, a video decoder, and a tuner. Further, the scaler 22 converts the video signal transmitted from the video signal converter 21 to have a vertical frequency, a resolution, a screen size, etc., suitable for an output specification of the display part 30.

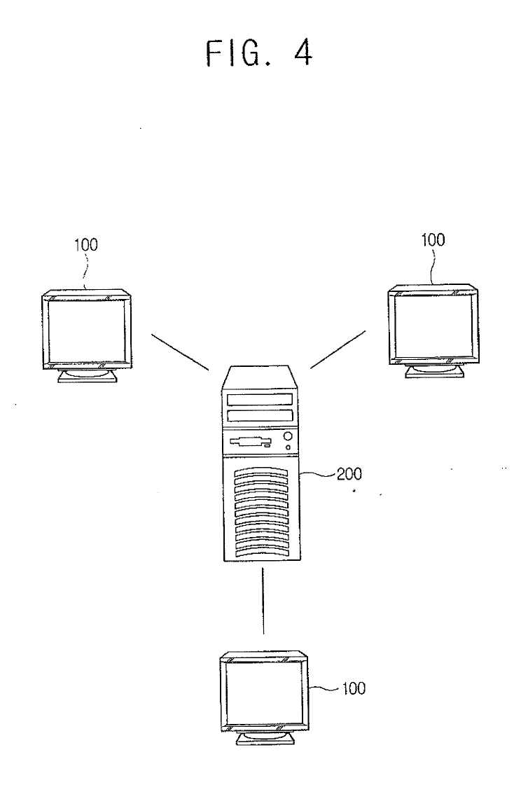

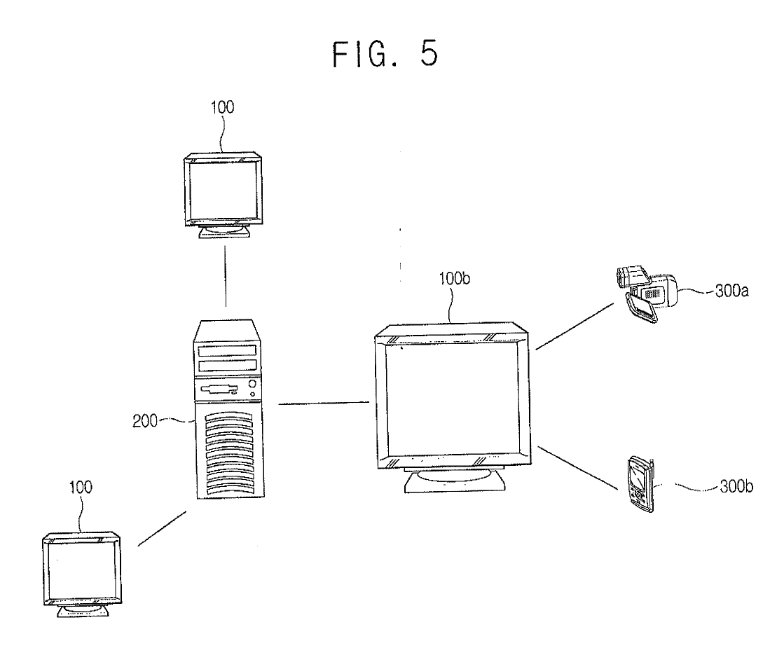

The video signal input part 10 receives the video signal of various formats from a computer 200 (refer to FIGS. 4 and 5), and outputs the video signal to the video signal processor 20. Here, the video signal input part 10 is provided to receive the video signal having various formats corresponding to the configuration of the video signal converter 21 of the video signal processor 20. For example, the video signal input part 10 can include an analog input terminal such as a D-SUB connection terminal, a composite connection terminal, a component connection terminal, etc., to receive an analog video signal and output it to the A/D converter; and a digital input terminal such as a DVI connector terminal, etc., to support a digital video signal input.

The controller 40 controls the video signal processor 20, the video signal input part 10, and the display part 30. Here, the controller 40 controls the video signal processor 20, the video signal input part 10, and the display part 30 to change a display state of a picture displayed on the display part 30 on the basis of preset variables.

The network module 60 is connected to a network through a through a local area network (LAN) or the like, and transmits/receives data through a predetermined protocol. Preferably, the network module 60 transmits/receives data through transmission control protocol/Internet protocol (TCP/IP), and has its own IP address. Thus, the computer 200 provides video data, audio data, or viewer data (to be described later) to the IP address of the display apparatus 100 connected to the computer 200 through the network.

The video reproducer 50 reproduces the video data as the video signal to be processed by the video signal processor 20. Here, the controller 40 abstracts the video data, e.g., the video data coded with a moving picture experts group (MPEG)-2 format or the like, from data received through the network module 60, and transmits the video data to the video reproducer 50.

At this time, the video reproducer 50 decodes the coded video data and reproduces the video data as a video signal to be processed by the video signal processor 20. The video reproducer 50 comprises an MPEG decoder to decode the video data coded with the MPEG-2 format. However, the video reproducer 50 may comprise various decoders according to coding formats of the video data.

Further, the video reproducer 50 according to an exemplary embodiment of the present invention can reproduce the video data as the video signal to be processed by the scaler 22, i.e., as digital red, green, blue (RGB) signals. Thus, the video signal output from the video reproducer 50 can be inputted to the scaler 22 without being converted by the video signal converter 21, thereby eliminating video signal loss due to the conversion performed by the video signal converter 21. Alternatively, the video reproducer 50 can reproduce the video data as the video signal to be processed by the scaler 22, i.e., as analog RGB signals.

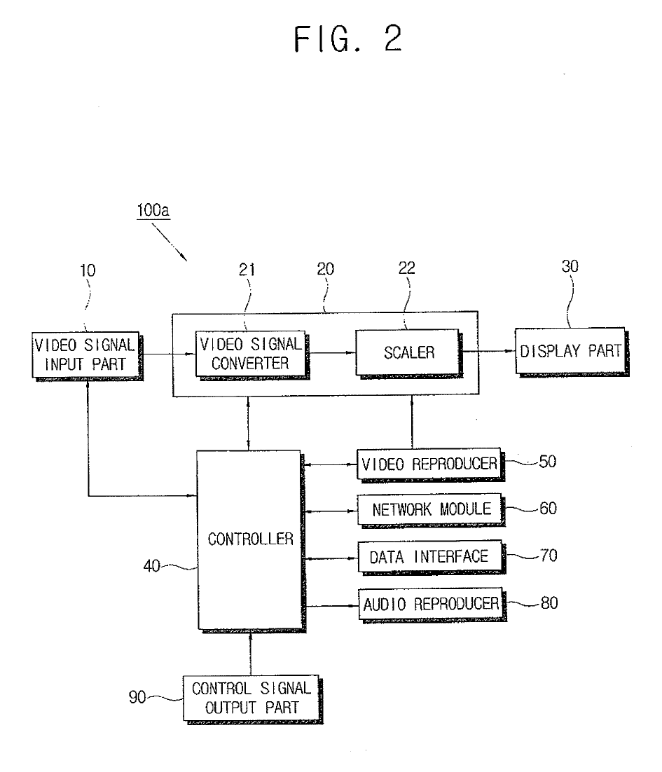

FIG. 2 is a control block diagram of a display apparatus 100a according to another exemplary embodiment of the present invention. As shown in FIG. 2, the display apparatus 100a according to another exemplary embodiment of the present invention further comprises an audio reproducer 80 to reproduce audio data. Here, the controller 40 abstracts the audio data from data received through the network module 60 and controls the audio reproducer 80 to reproduce the audio data.

Here, the audio reproducer 80 according to an exemplary embodiment of the present invention comprises an MPEG-2 decoder and/or an AC-3 decoder to decode the audio data coded with the MPEG-2 format or AC-3 format. Further, the audio reproducer 80 may comprise a speaker and a D/A converter converting the audio data decoded by the MPEG-2 decoder and/or the AC-3 decoder into an analog signal and outputting the analog signal through the speaker.

Further, as shown in FIG. 2, the display apparatus 100a comprises a data interface 70 connected to external devices (refer to FIG. 5) such as a digital camcorder 300a, a mobile phone 300b, etc., and allowing the data to be transmitted to/received from the external devices 300a, 300b. Here, the controller 40 receives the data through the data interface 70 and abstracts the video data and the audio data from the received data. Further, the controller 40 controls the video reproducer 50 and the audio reproducer 80 to reproduce and output the video data and the audio data, respectively.

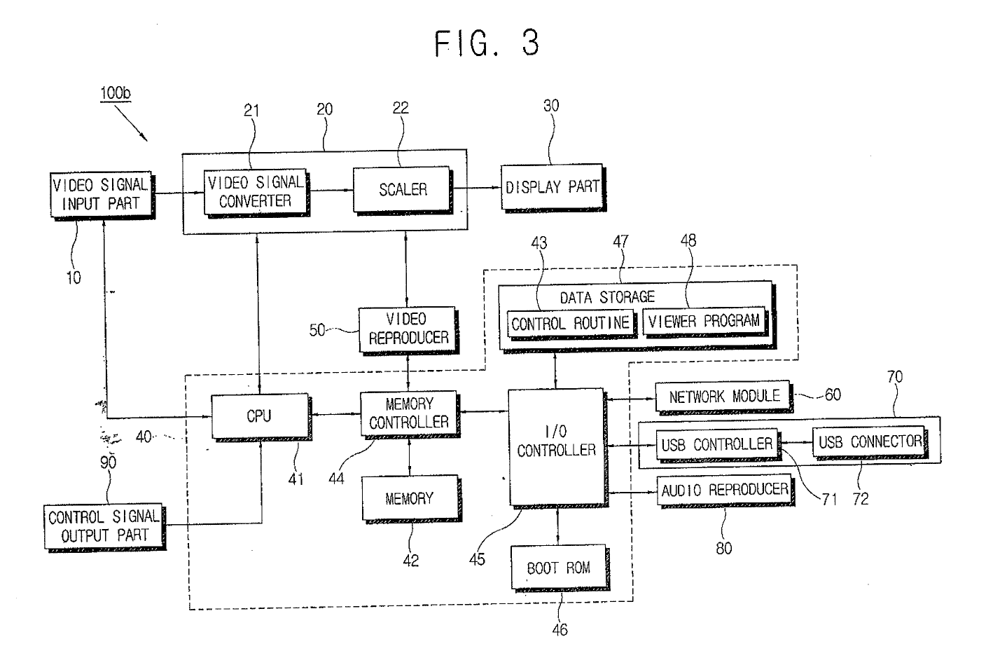

Here, the data interface 70 according to an exemplary embodiment of the present invention is connected to external devices 300a, 300b through a universal serial bus (USB) by way of example. Thus, as shown in FIG. 3, the data interface 70 comprises a USB connector 72 and a USB controller 71.

Hereinbelow, the display apparatus 100a of FIG. 2 will be described in more detail with reference to FIG. 3. As shown in FIG. 3, the controller 40 according to an exemplary embodiment of the present invention comprises a control routine 43, a memory 42, and a central processing unit (CPU) 41.

The control routine 43 is a set of processing routines for controlling the video reproducer 50, the network module 60, the audio reproducer 80 and the data interface 70. The control routine 43 according to an exemplary embodiment of the present invention may be provided as an operating system (OS) controlling the video reproducer 50, the network module 60, the audio reproducer 80 and the data interface 70. Here, the control routine 43 can be stored in a rewritable data storage 47, e.g., a flash disk module (FDM), a hard disk drive (HDD), etc.

The CPU 41 loads the control routine 43 stored in the data storage 47 into the memory 42 and executes the control routine 43, interlocking with a memory controller 44 controlling the memory 42. Thus, the CPU 41 controls the video reproducer 50, the network module 60, the audio reproducer 80 and the data interface 70.

Here, the memory 42 comprises at least one synchronous dynamic random access memory (SDRAM), and may comprise another type memory as necessary.

Further, the controller 40 according to an exemplary embodiment of the present invention comprises a boot read only memory (ROM) 46 storing a boot loader to check and initialize the video reproducer 50, the network module 60, the audio reproducer 80 and the data interface 70 when electric power is supplied to the display apparatus 100b. Here, when the electric power is supplied to the display apparatus 100b, the boot loader initializes the video reproducer 50, the network module 60, the data interface 70 and the audio reproducer 80 through a predetermined booting process, and then transfers authority to control the display apparatus 100b to the control routine 43.

Further, the controller 40 according to an exemplary embodiment of the present invention comprises an input/output (I/O) controller 45 controlling data input/output between the memory controller 44, the data storage 47, the boot ROM 46, the network module 60, the data interface 70 and the audio reproducer 80.

Further, the display apparatus 100b according to an exemplary embodiment of the present invention comprises a viewer program 48 operating on the basis of the control routine 43. Preferably, the viewer program 48 is stored in the data storage 47, but may be stored in a separate storage.

Here, the viewer program 48 converts data readable to itself (hereinafter, referred to as “viewer data”) into video data to be reproduced by the video reproducer 50. At this time, the processing routine abstracts the viewer data to be reproduced by the viewer program 48 from the data received through the network module 60, and controls the viewer program 48 to reproduce the abstracted viewer data.

For example, when viewer data such as a text file written in MS word of Microsoft Corporation is received through the network module 60, the processing routine determines the viewer program 48 corresponding to the viewer data on the basis of an extension (in this case, “doc”) of the text file. At this time, the viewer program 48 converts the viewer data to be reproduced by the video reproducer 50, so that the display part 30 displays a picture based on the viewer data processed through the video reproducer 50 and the video signal processor 20.

Further, as shown in FIG. 3, the display apparatus 100b according to an exemplary embodiment of the present invention comprises a control signal output part 90 to output a first control signal and a second control signal to the CPU 41 according to a user's handling.

When the CPU 41 receives the first control signal, the control routine 43 allows the data received through the network module 60 or the data interface 70 to be stored in the data storage 47.

Further, when the CPU 41 receives the second control signal, the control routine 43 reads out the data stored in the data storage 47, and allows the video reproducer 50 or the audio reproducer 80 to reproduce the read data.

Here, the control signal output part 90 according to an exemplary embodiment of the present invention comprises a control button provided in a front of the display apparatus 100b or as a remote controller.

Further, the control routine 43 according to an exemplary embodiment of the present invention provides a graphic user interface (GUI, not shown) through the display part 30. Through the GUI, a user inputs various control signals by handling the control signal output part 90, thereby controlling the video reproducer 50, the network module 60, the audio reproducer 80 and the data interface 70 on the basis of the control signal transmitted from the control signal output part 90.

FIG. 4 is a view illustrating configurations of a display system according to an exemplary embodiment of the present invention. As shown therein, a display system according to an exemplary embodiment of the present invention comprises a plurality of display apparatuses 100, and a computer 200.

Here, at least one of the display apparatuses 100 includes a display apparatus according to the foregoing exemplary embodiments of the present invention. FIG. 4 shows that the display apparatus 100 illustrated in FIG. 1 is connected to the computer 200 through the network.

Thus, in the display system according to an exemplary embodiment of the present invention, the computer 200 transmits the video data to the display apparatuses 100 through the network, so that the plurality of display apparatuses 100 can be connected to one computer 200.

FIG. 5 is a view illustrating configurations of a display system according to another exemplary embodiment of the present invention. As shown therein, the display system according to an exemplary embodiment of the present invention comprises a plurality of display apparatuses 100, 100b, a computer 200, and external devices 300a, 300b.

Here, at least one of the display apparatuses 100, 100b includes the display apparatus illustrated in FIG. 3. The external devices 300a, 300b are connected to the data interface 70 of the display apparatus 100b.

In the display system, the computer 200 is connected to the plurality of the display apparatuses 100, 100b through the network, and transmits the video data to the display apparatuses 100, 100b. Further, the display apparatuses 100, 100b are connected to external devices such as the digital camcorder 300a or the mobile phone 300b, communicates the data with the external devices 300a, 300b, and reproduces the data received from the external devices 300a, 300b by the display part 30 or the audio reproducer 80.

In the foregoing exemplary embodiment, the video reproducer 50 comprises a hardware component to decode the coded video data, e.g., an MPEG decoder or the like. However, the video reproducer 50 may comprise a software program operating on the basis of the control routine 43 to reproduce the video data, e.g., a codec program. Here, the codec program is stored in the data storage 47.

Further, in the foregoing exemplary embodiment, the video reproducer 50 and the memory controller 44 are separately provided. However, the memory controller 44 may be provided integrally with a graphic engine as one chipset.

Thus, there are provided the video reproducer 50 reproducing the video data to be processed by the video signal processor 20, the network module 60 connected to the network and transmitting/receiving the data through a predetermined protocol, and the controller 40 abstracting the video data from the data received through the network module 60, controlling the video reproducer 50 to reproduce the video data as the video signal to be processed by the video signal processor 20, and transmitting the video signal to the video signal processor 20, so that the display apparatuses 100, 100b are connected to the computer 200 through the network and display a picture based on the video data received from the computer 200 through the network, thereby allowing the plurality of the display apparatuses to be connected to one computer 200 through the network.

Further, there is additionally provided the data interface 70 connected to external devices 300a, 300b and communicating the data with the external devices 300a, 300b, so that the display apparatuses 100, 100b can display pictures based on data received from the external devices 300a, 300b.

As described above, the present invention provides a display apparatus and a display system, in which a plurality of display apparatuses is connected to a computer through a network and displays a picture based on data received from the computer through the network.

Further, the present invention provides a display system in which a display apparatus is connected to an external device and displays a picture based on data received from the external device.

Although exemplary embodiments of the present invention have been shown and described, it will be appreciated by those skilled in the art that changes may be made in these exemplary embodiments without departing from the principles and spirit of the invention, the scope of which is defined in the appended claims and their equivalents.

What is claimed is:

1. A display apparatus comprising:
a display part;
a video signal processor receiving a television broadcasting signal and processing the television broadcasting signal to be displayed by the display part;
a network module connected to a network and receiving a video data through a predetermined protocol;
a video reproducer reproducing the video data into a video signal to be processed by the video signal processor; and
a controller controlling one of the television broadcast signal and the video signal to be displayed by the display part.

2. The display apparatus according to claim 1, wherein the network module receives the video data which is stored in a server through a local area network (LAN).

3. The display apparatus according to claim 2, wherein the server comprises a personal computer.

4. The display apparatus according to claim 1, further comprising a data interface connected to an external device and receiving data from the external device,
wherein the controller processes the data received through the data interface.

5. The display apparatus according to claim 4, wherein the data interface is connected to the external device through a Universal Serial Bus.

6. The display apparatus according to claim 1, wherein the video data received through the network module is coded with a moving picture experts group (MPEG)-2 format,
the video reproducer comprises a MPEG decoder to decode the video data coded with the MPEG-2 format and
the controller controls the MPEG decoder to decode the video data to be displayed by the display part.
